(19) United States
(12) Patent Application Publication
(10) Pub. No.: US 2026/0113798 A1
(43) Pub. Date: Apr. 23, 2026

(54) FAST ATTACH PROCEDURES FOR MESH NETWORKS

(71) Applicant: Apple Inc., Cupertino, CA (US)

(72) Inventors: Arun Vijayakumari MAHASENAN, Fremont, CA (US); Venkateswara Rao MANEPALLI, San Jose, CA (US); Sarvesh Kumar VARATHARAJAN, Milpitas, CA (US)

(21) Appl. No.: 19/354,838

(22) Filed: Oct. 9, 2025

Related U.S. Application Data
(60) Provisional application No. 63/708,688, filed on Oct. 17, 2024.

(51) Int. Cl. H04W 76/19; H04W 24/02

(52) U.S. Cl. CPC H04W 76/19; H04W 24/02

(57) ABSTRACT

The subject technology provides for fast attach procedures for mesh networks. A device that receives a parent request from an unattached device may dynamically reduce a jitter time for responding to the parent request, if certain criteria for the parent device are met. The unattached device may choose, as its parent device, a first prospective parent device that responds to a parent request and meets certain criteria. A time for a device to re-attach to a mesh network after an outage may also be reduced. For example, a device may store a detach time at which it is detached from the mesh network in persistent memory, and may initiate full attach procedures if a time since the detach time is greater than a threshold, rather than first attempting to re-attach to a prior parent using a previous child identifier that is no longer valid.

### CROSS REFERENCE TO RELATED APPLICATIONS

This application claims the benefit of priority to U.S. Provisional Ser. No. 63/708,688, entitled, “Fast Attach Procedures for Mesh Networks”, filed on Oct. 17, 2024, the disclosure of which is hereby incorporated herein in its entirety.

### TECHNICAL FIELD

The present description generally relates to wireless communication systems and, in particular to, fast attach procedures for mesh networks.

### BACKGROUND

A mesh network may include router devices to forward packets between end devices of the network. End devices may attach to a parent device, such as a router. The end devices may communicate with that router of the network but may not forward packets for other network devices.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in accordance with one or more implementations.

FIG. 2 illustrates a block diagram of an example system for mesh network communication in accordance with one or more implementations.

FIG. 3 illustrates an example of a mesh network and an unattached device in accordance with one or more implementations.

FIG. 4 is a sequence diagram illustrating example operations that may be performed for attaching a new device to a mesh network in accordance with one or more implementations.

FIG. 5 is a sequence diagram illustrating example operations that may be performed by a detached end device in accordance with one or more implementations.

FIG. 6 is a flow chart of an example process that may be performed by a potential parent device for attach of a new end device in accordance with one or more implementations.

FIG. 7 is a flow chart of an example process that may be performed by an unattached device for attach to a parent device in accordance with one or more implementations.

FIG. 8 is a flow chart of an example process that may be performed by an end device for re-attaching to a mesh network in accordance with one or more implementations.

FIG. 9 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Aspects of the present disclosure relate to enabling communication between devices of a network. In one or more implementations, the network may include a mesh network, and communication between devices on the network may be performed in accordance with a mesh network communication protocol for the mesh network. In one or more implementations, the mesh network communication protocol may be a Thread® network protocol, as defined in the Thread 1.3.0 Specification. However, the disclosed subject matter is applicable to any networking environment.

Aspects of the subject technology can help to reduce the time for a new (e.g., unattached) device to join a mesh network by reducing the time for the new device to identify a parent device for attachment. For example, a parent device that receives a parent request from the new device may help to reduce the time for the new device to attach by dynamically reducing a jitter time for responding to the parent request, if certain criteria for the parent device are met. The new device may help to reduce the time for the new device to attach by choosing, as its parent device, a first prospective parent device that responds to a parent request and meets certain (e.g., same or other) criteria. In this way, fast (e.g., reduced time) attach procedures for mesh networks may be provided.

In one or more implementations, the time for a device to re-attach to a mesh network after an outage or other disconnection or detachment may also be reduced. For example, a device may store a detach time at which it is detached from the mesh network in persistent memory. When the network is again available, if an amount of time that has passed since the detach time is greater than a threshold time, the device may initiate full attach procedures (e.g., to join the mesh network as a new child device), rather than first attempting to re-attach to a prior parent using a previous child identifier that is no longer valid.

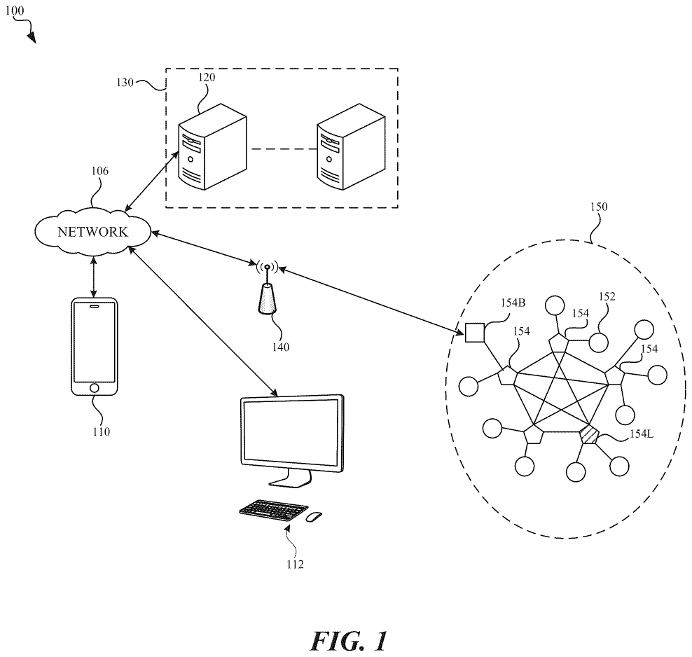

FIG. 1 illustrates an example network environment 100 in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The following description is provided for the network environment 100, which may operate in conjunction with the IEEE 802.15.4 standards for low-rate wireless personal area networks (LR-WPANs). It is understood that the concepts disclosed herein may also be applied to other networks, including Thread®, Zigbee®, Z-Wave®, Bluetooth Low Energy (BLE), ISA100.11a, WirelessHART®, MiWi™, IPv6 over Low-Power Wireless Personal Area Networks (6LoWPAN), Subnetwork Access Protocol (SNAP), Wi-Fi mesh networks, and the like.

In the example of FIG. 1, the network environment 100 includes an electronic device 110, an electronic device 112, a server 120, an access point 140 and a mesh network 150. The network 106 may communicatively (directly or indirectly) couple the electronic device 110 and/or the server 120. In one or more implementations, the network 106 may be an interconnected network of devices that may include, or may be communicatively coupled to, the Internet. For explanatory purposes, the network environment 100 is illustrated in FIG. 1 as including the electronic device 110, the electronic device 112, and the server 120; however, the network environment 100 may include any number of electronic devices and any number of servers or a data center including multiple servers.

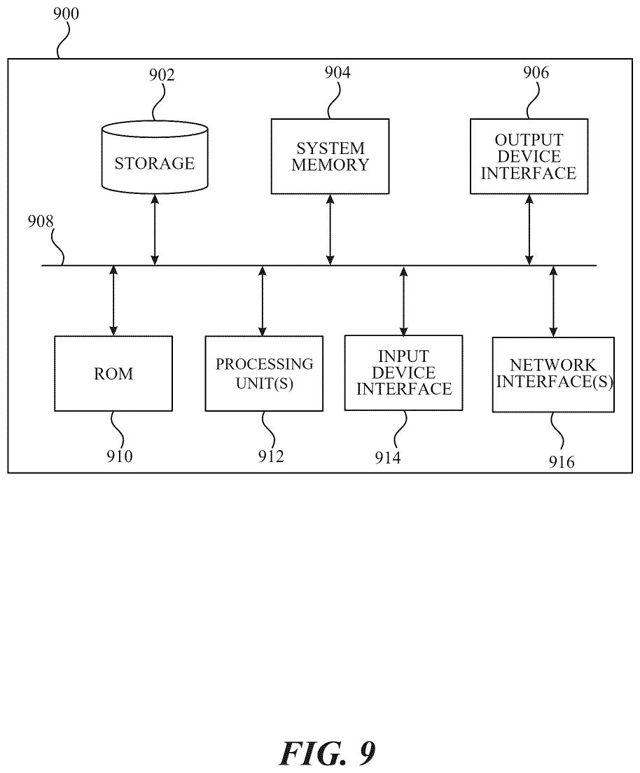

The electronic device 110 may be, for example, a desktop computer, a portable computing device such as a laptop computer, a smartphone, a peripheral device (e.g., a digital camera, headphones), a tablet device, a router, a wearable device such as a watch, a band, and the like. In FIG. 1, by way of example, the electronic device 110 is depicted as a mobile electronic device (e.g., smartphone). The electronic device 110 may be, and/or may include all or part of, the electronic system discussed below with respect to FIG. 9.

The electronic device 112 may be, for example, desktop computer, a portable computing device such as a laptop computer, a smartphone, a peripheral device (e.g., a digital camera, headphones), a tablet device, a router, a wearable device such as a watch, a band, and the like. In FIG. 1, by way of example, the electronic device 112 is depicted as a desktop computer. The electronic device 112 may be, and/or may include all or part of, the electronic system discussed below with respect to FIG. 9.

The server 120 may form all or part of a network of computers or a group of servers 130, such as in a cloud computing or data center implementation. For example, the server 120 stores data and software, and includes specific hardware (e.g., processors, graphics processors and other specialized or custom processors) for rendering and generating content such as graphics, images, video, audio and multi-media files. In an implementation, the server 120 may function as a cloud storage server that stores any of the aforementioned content generated by the above-discussed devices and/or the server 120.

In the example of FIG. 1, the electronic device 110 is depicted as a smartphone. However, it is appreciated that the electronic device 110 may be implemented as another type of device, such as a wearable device (e.g., a smart watch or other wearable device). The electronic device 110 may be a device of a user (e.g., the electronic device 110 may be associated with and/or logged into a user account for the user at a server). Although a single electronic device 110 is shown in FIG. 1, it is appreciated that the network environment 100 may include more than one electronic device, including more than one electronic device of a user and/or one or more other electronic devices of one or more other users. Although the electronic device 110 and the electronic device 112 are depicted as being outside the mesh network 150, in various use cases, and/or at various times, the electronic device 110 and/or the electronic device 112 may be included in the mesh network 150.

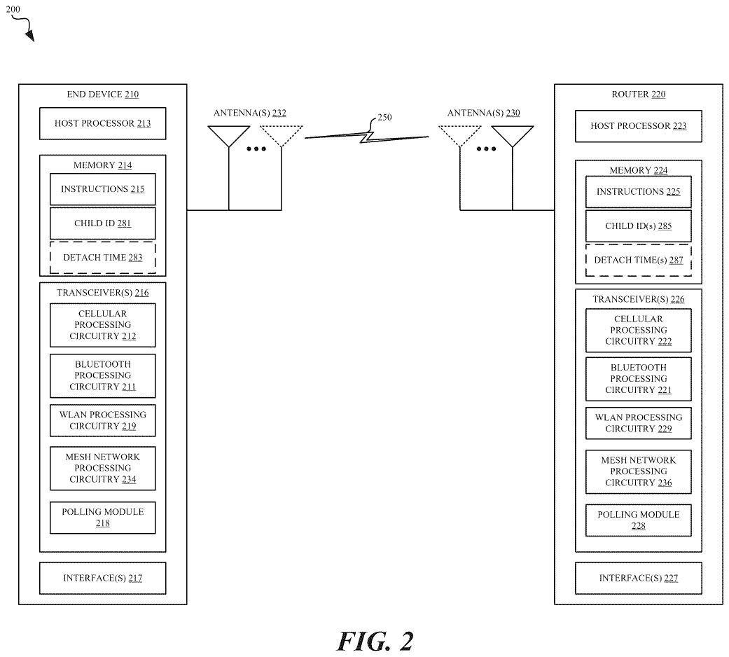

In the example of FIG. 1, the mesh network 150 includes various end devices 152 and routers 154 (each of which may include any one of the electronic devices 110 or 112, and/or other electronic devices). In one or more implementations, the routers 154 (represented as pentagons in the figure) may forward packets (e.g., data) between and/or to the end devices 152 (represented as circles in the figure) of the mesh network 150. In some use cases, a router 154 may transmit a packet via a radio or transceiver, such as the transceiver 226 of FIG. 2, to a targeted end device 152 via another router 154. The routers 154 may also provide secure commissioning services for other devices attempting to join the mesh network 150. The transceiver 226 of each router 154 may be enabled at times for a specified duration to receive and transmit packets.

In one or more implementations, the end devices 152 and the routers 154 may communicate according to a mesh network communication protocol (e.g., a Thread® network protocol) for the mesh network 150. For example, the mesh network communication protocol may govern how a device acting as a router 154 forwards packets between end devices 152 of the mesh network 150. In one or more implementations, each device acting as a router 154 may act as a parent device for one or more of the end devices 152. The parent device may provide connectivity for, and manage communication with, the end devices that are child devices of that parent device. As such, an end device 152 may utilize a radio thereof to transmit a message to another end device 152, e.g., over the mesh network 150, via at least its parent router 154. As shown in FIG. 1, a mesh network, such as mesh network 150, may include multiple devices acting as routers 154. Devices that may act as routers 154 in the mesh network 150 may include devices that are specifically implemented (e.g., in hardware) as routers, and/or router-eligible end devices that can act as end devices and can perform router operations for other end devices.

Each end device 152 of the mesh network 150 may communicate primarily with a single router 154, which may be referred to as a parent (or parent device) of that end device 152. For example, the end devices 152 may not forward packets for other network devices (e.g., end devices 152 and router 154).

In various implementations and/or use cases, the roles of various devices in the mesh network 150 may be dynamic. For example, if a router 154 does not have any child devices (e.g., communicatively coupled end devices 152), the router 154 may be downgraded and/or configured to operate as an end device 152. In another example, if a new end device attempting to join the mesh network 150 is within range of a current end device 152 of the mesh network 150 (but not a router 154), and that end device 152 is eligible to become a router 154 (e.g., is a router-eligible end device (REED)), that end device 152 may be upgraded and/or configured to operate as a router 154 for the new end device 152. In that case, the new router 154 acts as a router 154 with respect to the new end device and may be communicatively coupled to one or more other routers 154 of the mesh network 150.

In one or more implementations, a router 154 (e.g., including the leader 154L) may act as a parent device for an end device 152 that is a sleepy end device (SED), such as by buffering incoming data while the SED is in a sleep state. This procedure involves a downlink message to the SED, where the router 154 buffers the data until the SED awakens and queries for the data, known as the polling procedure. The SED then keeps its receiver (e.g., receiver portion of the transceiver 216 of FIG. 2) active for a specified duration to receive the incoming data.

Examples of device that can operate as end devices 152 include a cellular phone, a smart phone, a session initiation protocol phone, a laptop, a satellite radio, a global positioning system, a multimedia device, a video device, a digital audio player, a personal digital assistant, a camera, a game console, a tablet, a smart device, a wearable device, a vehicle, an electric meter, a gas pump, a kitchen appliance, a healthcare device, an implant, a sensor, an actuator, a display, or any other similar functioning device. Some or all of the end devices 152 may be referred to as Internet-of-Things (IoT) devices. Some or all of the end devices 152 may have the capability of acting as a router 154, some of the end devices 152 may not have the capability of acting as routers, and/or some of the routers 154 may be specifically implemented (e.g., in hardware) as routers and may not have the capability of acting as an end device. As examples, the routers 154 may be implemented as routers or router-enable end devices (REEDs) that can act as routers or end devices. Examples of REEDs include a cellular phone, a smart phone, a session initiation protocol phone, a laptop, a satellite radio, a global positioning system, a multimedia device, a video device, a digital audio player, a personal digital assistant, a camera, a game console, a tablet, a smart device, a wearable device, a vehicle, an electric meter, a gas pump, a kitchen appliance, a healthcare device, an implant, a sensor, an actuator, a display, or any other similar functioning device with the capability (e.g., hardware and software capabilities) of acting as a router (e.g., forwarding packets for other devices).

In one or more implementations, a router 154 of the mesh network 150 may perform a leader role for the mesh network 150. For example, the mesh network 150 of FIG. 1 includes a router 154 that serves as a leader 154L (e.g., a leader node) in the mesh network 150. For example, the leader 154L may perform a leader role in the mesh network. In one or more implementations, performing the leader role may include managing the overall network structure and operation of the mesh network 150, including initialization, synchronization, and topological control. Performing the leader role may include aggregating and distributing network-wide confirmation information to the other routers 154 and the end devices 152 of the mesh network 150. Performing the leader role may include determining whether a router-eligible end device (REED) acting as an end device 152 in the mesh network 150 is authorized to upgrade to act as a router 154 in the mesh network 150, and/or determining whether a REED acting as a router 154 in the mesh network 150 is authorized to downgrade to act as an end device 152 in the mesh network 150.

In one or more implementations, a router 154 of the mesh network 150 may forward information between the mesh network and a non-mesh network, such as a Wi-Fi network. For example, the border router 154B may forward information between the mesh network 150 and a non-mesh network, such as the network 106, such as through the access point 140. In that case, the router may be referred to as a border router 154B, and may convert a Wi-Fi message to the mesh network communication protocol and transmit the converted mesh network message to a target end device 152 for the message using a mesh network radio. For explanatory purposes, only the border router 154B is illustrated as being connected to the access point 140, however, it is appreciated that the mesh network 150 may include more than one border router (e.g., one or more of the other routers 154 may also be configured to act as a border router 154B) connected to the access point 140 in some implementations.

FIG. 2 illustrates a block diagram of an example of a system 200 including an end device and a router of a mesh network in accordance with one or more implementations. The system 200 may be a portion of the network environment 100. The end device 210 may be, for example, one of the end devices 152 of the mesh network 150. The router 220 may be, for example, one of the routers 154 of the mesh network 150. In one or more use cases, the router 220 may be a parent device to the end device 210 (e.g., the end device 210 may be a child device of the router 220).

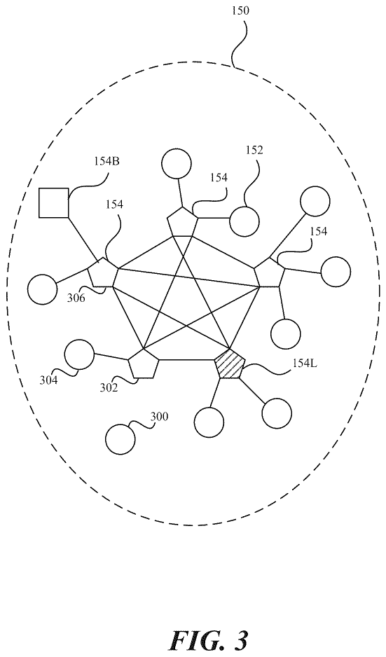

As shown in FIG. 2, the end device 210 may include a host processor 213. The host processor 213 may execute instructions such that various operations of the end device 210 are performed. For example, the host processor 213 can serve as the CPU responsible for executing instructions and managing various tasks, such as one or more of the operations described herein in connection with FIGS. 3-8. The host processor 213 can include multiple cores, each capable of handling multiple threads simultaneously, enabling multitasking. The host processor 213 can integrate various components such as arithmetic logic units (ALUs), registers, cache memory, and control units to execute instructions and process data. Additionally, the host processor 213 can include integrated DSPs, graphics processing units (GPUs), neural processing units (NPUs), and hardware accelerators for enhanced performance in tasks such as multimedia processing, artificial intelligence (AI), and gaming. The host processor 213 may be implemented using, for example, an ASIC, a controller, a FPGA device, another hardware device, a firmware device, or any combination thereof configured to perform the operations described herein.

The end device 210 may include one or more transceiver(s) 216 that may include radio frequency (RF) transmitter and/or receiver circuitry that use the antenna(s) 232 of the end device 210 to facilitate communication (e.g., the signaling 250) to and/or from the end device 210 with other devices (e.g., the router 220) according to corresponding wireless communication protocols (e.g., Thread, cellular, Wi-Fi, Bluetooth). The one or more transceivers 216 can be responsible for both transmitting and receiving radio signals. The one or more transceivers 216 can facilitate wireless communication by converting digital data into radio waves for transmission and then converting received radio waves back into digital data for the end device 210 to process. The one or more transceivers 216 can operate within specific frequency bands allocated for wireless communication and may employ various modulation techniques to optimize data transmission efficiency and reliability. In one or more implementations, the one or more transceiver(s) 216 are not limited to specific wireless communication protocols, including Bluetooth, Thread®, Wi-Fi, cellular, among others, as it is appreciated that other wireless communication protocols and/or technologies can be associated with the one or more transceiver(s) 216.

The end device 210 may include memory 214. The memory 214 may include a non-transitory computer-readable storage medium that stores instructions 215 (which may include, for example, the instructions being executed by one or more components in the transceiver 216 and/or the host processor 213). The instructions 215 may also be referred to as program code or a computer program. The memory 224 may also store data used by, and results computed by, the transceiver 216 and/or the host processor 213. As shown in FIG. 2, the end device 210 may store a child identifier (ID) 281. For example, the child ID 281 may be an identifier for the end device 210 that has been provided to the end device 210 (e.g., by the router 220) during an attachment procedure for attaching the end device 210 to the mesh network 150. In one or more implementations, the child ID 281 may be stored in persistent memory at the end device 210 so that the end device 210 can use the child ID 281 to attempt to re-attach to the mesh network 150 in the event of a detachment or disconnection of the end device 210 from the mesh network 150. In one or more implementations as discussed in further detail hereinafter, in the event of a detachment or disconnection from the mesh network, the end device 210 may store a detach time 283, which indicates the time at which the end device 210 was detached from the mesh network.

The end device 210 may include cellular processing circuitry 212. The cellular processing circuitry 212 is responsible for handling communication tasks related to the transmission and reception of wireless signals. The cellular processing circuitry 212 is specialized for managing the modulation, demodulation, encoding, decoding, and other signal processing tasks necessary for cellular communication. The cellular processing circuitry 212 can interface with the RF components and antenna(s) (e.g., the one or more antennas 232) to transmit and receive data, voice, and other multimedia content over wireless networks such as Global System for Mobile Communications (GSM), CDMA, LTE, and 5G. The cellular processing circuitry 212 also manages power control, signal quality monitoring, and handover procedures to ensure reliable and efficient communication. The cellular processing circuitry 212 may execute instructions such that various operations of the end device 210 are performed, as described herein. The cellular processing circuitry 212 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The end device 210 may include Bluetooth processing circuitry 211. The Bluetooth processing circuitry 211 is responsible for managing the transmission and reception of wireless signals to and from mobile devices (e.g., end device 210) for Bluetooth communication. The Bluetooth processing circuitry 211 can perform various signal processing tasks related to modulation, demodulation, encoding, decoding, and error correction to ensure reliable communication over the air interface. The Bluetooth processing circuitry 211 may execute instructions such that various operations of the end device 210 are performed, as described herein. The Bluetooth processing circuitry 211 may include one or more baseband processors implemented using, for example, a CPU, a DSP, an ASIC, a controller, an FPGA device, another hardware device, a firmware device, or any combination thereof configured to perform the operations described herein.

The end device 210 may include WLAN processing circuitry 219. The WLAN processing circuitry 219 is responsible for managing the transmission and reception of wireless signals to and from mobile devices (e.g., end device 210) for Wi-Fi communication. The WLAN processing circuitry 219 can perform various signal processing tasks related to modulation, demodulation, encoding, decoding, and error correction to ensure reliable communication over the air interface. The WLAN processing circuitry 219 may execute instructions such that various operations of the end device 210 are performed, as described herein. The WLAN processing circuitry 219 may include one or more baseband processors implemented using, for example, a CPU, a DSP, an ASIC, a controller, an FPGA device, another hardware device, a firmware device, or any combination thereof configured to perform the operations described herein.

The end device 210 may include mesh network processing circuitry 234. The mesh network processing circuitry 234 is responsible for managing the transmission and reception of wireless signals to and from mobile devices (e.g., end device 210) for mesh network communication. The mesh network processing circuitry 234 can perform various signal processing tasks related to modulation, demodulation, encoding, decoding, and error correction to ensure reliable communication over the air interface. The mesh network processing circuitry 234 may execute instructions such that various operations of the end device 210 are performed, as described herein. The mesh network processing circuitry 234 may include one or more baseband processors implemented using, for example, a CPU, a DSP, an ASIC, a controller, an FPGA device, another hardware device, a firmware device, or any combination thereof configured to perform the operations described herein.

In one or more implementations, the one or more transceivers 216 can operate in conjunction with the mesh network processing circuitry 234 to facilitate mesh network communication. The one or more transceivers 216 may be responsible for converting digital data from the mesh network processing circuitry 234 into radio signals for transmission over the air and for receiving incoming radio signals, which are then converted back into digital data for processing by the mesh network processing circuitry 234. This collaboration enables the end device 210 to transmit and receive data, supporting functions such as voice calls, text messaging, Internet access, and other wireless services via the mesh network 150 of FIG. 1. The mesh network processing circuitry 234 manages the digital signal processing tasks, while the one or more transceivers 216 handle the analog RF operations, working together to enable wireless communication capabilities in the end device 210.

The end device 210 may include one or more antenna(s) 232 (e.g., one, two, four, or more). In implementations having multiple antenna(s) 230, the router 220 may perform multiple-in-multiple-out (MIMO), digital beamforming, analog beamforming, beam steering, etc. For implementations with multiple antenna(s) 232, the end device 210 may leverage the spatial diversity of such multiple antenna(s) 232 to send and/or receive multiple different data streams on the same time and frequency resources.

The end device 210 may include one or more interface(s) 217. The interface(s) 217 may be used to provide input to or output from the end device 210. For example, an end device 210 that is a UE may include interface(s) 217 such as microphones, speakers, a touchscreen, buttons, and the like to allow for input and/or output to the UE by a user of the UE. Other interfaces of such a UE may be made up of transmitters, receivers, and other circuitry (e.g., other than the transceiver(s) 216/antenna(s) 232 already described) that allow for communication between the UE and other devices and may operate according to known protocols (e.g., Wi-Fi®, Bluetooth®, and the like).

The end device 210 may include polling block 218. The polling block 218 may be implemented via hardware, software, or combinations thereof. For example, the polling block 218 may be implemented as a processor, circuit, and/or instructions 215 stored in the memory 214 and executed by the host processor 213 and/or the transceiver 216. In some examples, the polling block 218 may be integrated within the transceiver(s) 216. For example, the polling block 218 may be implemented by a combination of software components (e.g., executed by a DSP or a general processor) and hardware components (e.g., logic gates and circuitry) within the transceiver(s) 216. In other examples, the polling block 218 is a separate component from the transceiver(s) 216.

The router 220 may include a host processor 223. The host processor 223 may execute instructions such that various operations of the router 220 are performed. For example, the host processor 223 can serve as the central processing unit (CPU) responsible for executing instructions and managing various tasks, such as one or more of the operations described herein in connection with FIGS. 3-6. The host processor 223 can include multiple cores, each capable of handling multiple threads simultaneously, enabling multitasking. The host processor 223 can integrate various components such as ALUs, registers, cache memory, and control units to execute instructions and process data. Additionally, the host processor 223 can include integrated DSPs, GPUs, NPUs, and hardware accelerators. The host processor 223 may be implemented using, for example, an ASIC, a controller, a FPGA device, another hardware device, a firmware device, or any combination thereof configured to perform the operations described herein.

The router 220 may include one or more transceiver(s) 226 that may include RF transmitter and/or receiver circuitry that use antenna(s) 230 of the router 220 to facilitate signaling (e.g., the signaling 250) to and/or from the router 220 with other devices (e.g., the end device 210) according to corresponding wireless communication protocols (e.g., cellular, Wi-Fi, Bluetooth). The one or more transceivers 226 can be responsible for both transmitting and receiving radio signals. The one or more transceivers 226 can facilitate wireless communication by converting digital data into radio waves for transmission and then converting received radio waves back into digital data for the router 220 to process. The one or more transceivers 226 can operate within specific frequency bands allocated for wireless communication and may employ various modulation techniques to optimize data transmission efficiency and reliability. In one or more implementations, the one or more transceiver(s) 226 are not limited to specific wireless communication protocols, including Bluetooth, Thread®, Wi-Fi, cellular, among others, as it is appreciated that other wireless communication protocols and/or technologies can be associated with the one or more transceiver(s) 226.

The router 220 may include memory 224. The memory 224 may be a non-transitory computer-readable storage medium that stores instructions 225 (which may include, for example, the instructions being executed by one or more components in the transceiver 226 and/or the host processor 223). The instructions 225 may also be referred to as program code or a computer program. The memory 224 may also store data used by, and results computed by, the transceiver 226 and/or the host processor 223. A shown in FIG. 2, the router 220 may store one or more child IDs 285 of one or more child devices of the router 220 (e.g., including the child ID 281 that is also stored at the end device 210, if the end device 210 is a child device of the router 220). In one or more implementations, the router 220 may store one or more detach times 287, which indicate the time(s) at which one or more respective child devices detached or disconnected from the mesh network 150 (e.g., times at which the router 220 last received a communication from the child device(s)). In one or more implementations, the router 220 may store the child ID(s) 285 while the child device(s) are attached to the mesh network 150 (e.g., and while the router 220 is the parent of that/those child device(s)), and for a predetermined period of time after a detachment of a child device from the mesh network 150. After the predetermined period of time following the detachment of a child device has passed, the router 220 may delete the child ID 285 of that child device from its memory. In this way, a period of time is provided during which a child device can detach and re-attach to the mesh network 150 using the stored child ID, without performing a full (e.g., new) attachment procedure.

The router 220 may include cellular processing circuitry 222. The cellular processing circuitry 222 is responsible for managing the transmission and reception of wireless signals to and from mobile devices (e.g., end device 210). The cellular processing circuitry 222 can perform various signal processing tasks related to modulation, demodulation, encoding, decoding, and error correction to ensure reliable communication over the air interface. The cellular processing circuitry 222 may execute instructions such that various operations of the router 220 are performed, as described herein. The cellular processing circuitry 222 may include one or more baseband processors implemented using, for example, a CPU, a DSP, an ASIC, a controller, an FPGA device, another hardware device, a firmware device, or any combination thereof configured to perform the operations described herein.

The router 220 may include Bluetooth processing circuitry 221. The Bluetooth processing circuitry 221 is responsible for managing the transmission and reception of wireless signals to and from mobile devices (e.g., end device 210) for Bluetooth communication. The Bluetooth processing circuitry 221 can perform various signal processing tasks related to modulation, demodulation, encoding, decoding, and error correction to ensure reliable communication over the air interface. The Bluetooth processing circuitry 221 may execute instructions such that various operations of the router 220 are performed, as described herein. The Bluetooth processing circuitry 221 may include one or more processors implemented using, for example, a CPU, a DSP, an ASIC, a controller, an FPGA device, another hardware device, a firmware device, or any combination thereof configured to perform the operations described herein.

The router 220 may include WLAN processing circuitry 229. The WLAN processing circuitry 229 is responsible for managing the transmission and reception of wireless signals to and from mobile devices (e.g., end device 210) for Wi-Fi communication. The WLAN processing circuitry 229 can perform various signal processing tasks related to modulation, demodulation, encoding, decoding, and error correction to ensure reliable communication over the air interface. The WLAN processing circuitry 229 may execute instructions such that various operations of the router 220 are performed, as described herein. The WLAN processing circuitry 229 may include one or more processors implemented using, for example, a CPU, a DSP, an ASIC, a controller, an FPGA device, another hardware device, a firmware device, or any combination thereof configured to perform the operations described herein.

The router 220 may include mesh network processing circuitry 236. The mesh network processing circuitry 236 is responsible for managing the transmission and reception of wireless signals to and from mobile devices (e.g., end device 210) for mesh network communication. The mesh network processing circuitry 236 can perform various signal processing tasks related to modulation, demodulation, encoding, decoding, and error correction to ensure reliable communication over the air interface. The mesh network processing circuitry 236 may execute instructions such that various operations of the router 220 are performed, as described herein. The mesh network processing circuitry 236 may include one or more processors implemented using, for example, a CPU, a DSP, an ASIC, a controller, an FPGA device, another hardware device, a firmware device, or any combination thereof configured to perform the operations described herein.

In one or more implementations, the one or more transceivers 226 can operate in conjunction with the mesh network processing circuitry 236 to facilitate mesh network communication. The one or more transceivers 226 is responsible for converting digital data from the mesh network processing circuitry 236 into radio signals for transmission over the air and for receiving incoming radio signals, which are then converted back into digital data for processing by the mesh network processing circuitry 236. This collaboration enables the router 220 to transmit and receive data, supporting functions such as audio services, Internet access, and other wireless services via the mesh network 150 of FIG. 1. The mesh network processing circuitry 236 manages the digital signal processing tasks, while the one or more transceivers 226 handle the analog RF operations, working together to enable wireless communication capabilities in the router 220.

The router 220 may include one or more antenna(s) 230 (e.g., one, two, four, or more). In implementations having multiple antenna(s) 230, the router 220 may perform multiple-in-multiple-out (MIMO), digital beamforming, analog beamforming, beam steering, etc.

The router 220 may include one or more interface(s) 227. The interface(s) 227 may be used to provide input to or output from the router 220. For example, a router 220 may include interface(s) 227 made up of transmitters, receivers, and other circuitry (e.g., other than the transceiver(s) 226/antenna(s) 230 already described) that enables the router 220 to communicate with other equipment in the mesh network 150, and/or that enables the router 220 to communicate with external networks, computers, databases, and the like for purposes of operations, administration, and maintenance of the router 220 or other equipment operably connected thereto.

The router 220 may include a polling block 228. The polling block 228 may be implemented via hardware, software, or combinations thereof. For example, the polling block 228 may be implemented as a processor, circuit, and/or instructions 225 stored in the memory 224 and executed by one or more components in the transceiver 226. In some examples, the polling block 228 may be integrated within the transceiver(s) 226. For example, the polling block 228 may be implemented by a combination of software components (e.g., executed by a DSP or a general processor) and hardware components (e.g., logic gates and circuitry) within the transceiver(s) 226. In other examples, the polling block 228 is a separate component from the transceiver(s) 226.

In one or more implementations, multiple wireless communication protocols (e.g., mesh network and Bluetooth technologies) may coexist in an electronic device (e.g., electronic devices 110-112 of FIG. 1) with a shared radio that operates at 2.4 gigahertz for both Bluetooth and mesh network technologies. The integrated circuit (IC) chip responsible for modulation and demodulation, the software stack, the hardware stack, and the antennas for transmission and reception may all be shared resources between the Bluetooth and mesh network technologies. In one or more implementations, when the mesh network processing circuitry 234 is active, the Bluetooth processing circuitry 211 may not be active, and vice versa, resulting in time division multiplexing between the Bluetooth and mesh network technologies.

In one or more implementations, a device, such as an end device 152 (e.g., end device 210) may not be connected to, or attached to, the mesh network 150. For example, FIG. 3 illustrates a use case in which a device 300 (e.g., an end device 152, such as the end device 210) is an unattached device that is not connected to the mesh network 150. The device 300 may be a full thread device (FTD), such as a router-eligible end device (REED) or a full end device (FED), or a minimal thread device (MTD), such as a minimal end device (MED), a sleepy end device (SED), a synchronized sleepy end device (SSED), or a Bluetooth end device (BED) in various implementations. The device 300 may have never been connected to (e.g., attached to) the mesh network 150, or may have previously been connected to (e.g., attached to) the mesh network 150 and later disconnected to (e.g., detached from) the mesh network 150.

In order to join (e.g., attach to) the mesh network 150, if the device 300 is a new device to the mesh network 150 (e.g., has never attached, or has been detached for greater than a predetermined period of time), the device 300 may perform a full attach procedure. For example, the full attach procedure may include multicasting, by the device 300, a parent request (e.g., a Mesh Link Establishment (MLE) parent request). The parent request may be received by one or more devices of the mesh network 150, including one or more routers 154 (e.g., a potential parent device 302 and a potential parent device 306 that are near the device 300) and/or one or more end devices 152 (e.g., potential parent device 304) that are capable of upgrading to operate as routers 154 (e.g., one or more REEDs). The device 300 may receive a parent response (e.g., an MLE parent response) from one or more of the devices of the mesh network 150 (e.g., from a router 154, such as the potential parent device 302, the potential parent device 306, or the potential parent device 304) that received the parent request. The parent response(s) from each responding device may be unicast to the device 300. Once the parent response(s) have been received, the device 300 may select one of the devices (e.g., a router 154, such as the potential parent device 302) from which the parent response(s) were received as a parent device, and provide a child ID request (e.g., an MLE child ID request) to that selected parent device. The device 300 may then receive a child ID (e.g., child ID 281 of FIG. 2) from the selected parent device, and may store the received child ID in persistent memory at the device 300 (e.g., in memory 214). In one or more implementations, the selected parent device may also store the child ID in its memory (e.g., memory 224 of FIG. 2). Once the child ID is received, the device 300 may be attached to the mesh network and may (e.g., periodically) exchange information (e.g., link information, security information, channel information, and/or other network information) with the selected parent device to maintain the attachment to the mesh network.

In the event that, after attachment, the device 300 loses its connection with the selected parent device (e.g., and fails to send and/or receive the information for maintaining the attachment to the mesh network), the device 300 may use the stored child ID to attempt to re-attach to (e.g., to request and receive updated network connection and/or security information for re-attaching to the mesh network) the previously selected parent device without performing the full attach procedure (e.g., without requesting and selecting a new parent device, and without requesting and receiving a new child ID).

Sending parent requests, receiving parent responses, and selecting a parent device from among multiple devices of the mesh network 150 that provide parent responses to a parent request can be time consuming. Aspects of the subject disclosure may help to reduce the time for the new device to select and attach to a new parent device.

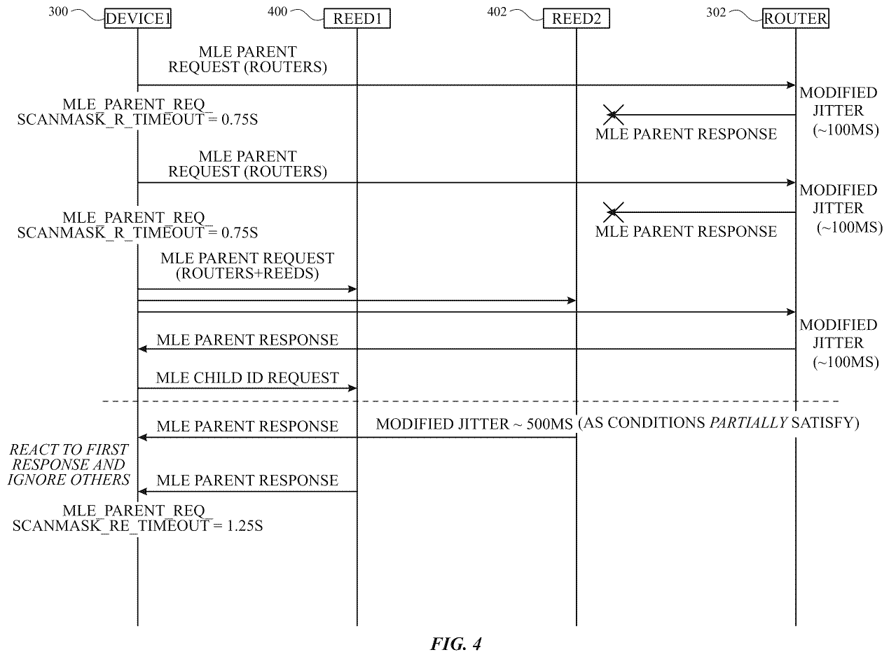

For example, FIG. 4 is a sequence diagram illustrating operations that may be performed by an unattached device and one or more potential parent devices for reducing the time to attachment for a new end device (e.g., a device 300 that is unattached to the mesh network). As shown in FIG. 4, the device 300 may initially send parent requests only to routers 154 of the mesh network 150. As shown, if a parent response to a parent request is not received at the device 300, the device 300 may wait for a predetermined timeout period (e.g., 0.75 seconds in some implementations) before sending a new parent request.

In one or more implementations, a potential parent device 302 may send a parent response to a parent request following a random jitter time. In order to reduce the amount of time for the device 300 to find a parent device, the potential parent device 302 may use (e.g., instead of using a static upper bound for a jitter value for sending the parent responses) a dynamic jitter value (e.g., a dynamic upper bound jitter value). For example, the potential parent device 302 may reduce its jitter time (e.g., the time the potential parent device 302 waits before sending a parent response to a received parent request) if the potential parent device 302 determines that it meets or satisfies one or more criteria for becoming the parent device. For example, the potential parent device 302 may modify its jitter time based on whether and/or how closely the potential parent device 302 satisfies the one or more criteria (e.g., the potential parent device 302 may use a small jitter of binary small jitter or large jitter options if any of the one or more criteria are satisfied, or may use a progressively smaller jitter when progressively more of the one or more criteria are satisfied and/or the one or more criteria are more closely satisfied). As examples, the one or more criteria may include mesh-impacting criteria, such as whether the potential parent device 302 is operating as a router 154 in the mesh network 150, whether a link quality of a connection between the potential parent device 302 and the device 300 is at least a threshold quality (e.g., the two-way link quality is rated as very good, or a value of three or higher), whether the potential parent device 302 has a parent priority value above a threshold priority value (e.g., a value, N), and/or whether the potential parent device 302 has a number of neighbor devices (e.g., a number of neighbor devices with good two-way link quality) in the mesh network 150 greater than a threshold number (e.g., a value, k) of neighbors.

As another example, the one or more criteria may include a child-impacting criterion, such as whether a version number for the potential parent device 302 is greater than a child version number of the device 300 (e.g., whether a version number in a version type-length-value (TLV) is equal to or greater than a child version of the device 300). For example, the parent request from the device 300 may include an indication of a child version number for the device 300, to which the potential parent device 302 can compare its own version number. As another example, the one or more criteria may include a child-impacting criterion, such as whether a buffer size (e.g., a RX-Off child buffer size indicated in a connectivity TLV) is greater than or equal to a desired buffer size of the device 300. For example, the parent request from the device 300 may include an indication of the desired buffer size for the device 300. As another example, the one or more criteria may include a child-impacting criterion, such as whether a datagram count (e.g., a RX-Off child datagram indicated in a connectivity TLV) for the potential parent device 302 is greater than or equal to a desired datagram count of the device 300. For example, the parent request from the device 300 may include an indication of the desired datagram count of the device 300.

In one or more implementations, potential parents that satisfy fewer of the criteria, or whose attributes satisfy the criteria but are further from preferred values, may have a longer jitter time than potential parent devices that satisfy relatively more of the criteria, or whose attributes satisfy the criteria and are closer to preferred values. By reducing the jitter time (e.g., from a default of 0.5 seconds or more to three hundred millisecond, two hundred milliseconds, or one hundred milliseconds, or less than one hundred milliseconds, such as depending on the amount of criteria that are satisfied by the parent) that the potential parent device 302 waits before sending the parent response in this way, the potential parent device 302 can reduce the time for attaching the device 300 to the mesh network 150.

As shown, if no parent response to the parent requests sent only to the routers is received at the device 300, after a number (e.g., a predetermined number, such as two) of parent requests sent only to the routers, the device 300 may send parent requests to both routers 154 and REEDs (e.g., REEDs that are currently operating in the mesh network 150 as end device 152, but are capable of upgrading to a router to act as a parent device to the device 300). In the example of FIG. 4, following two unanswered parent requests sent (e.g., spaced apart by the reduced jitter time) only to routers, a parent request is sent to the potential parent device 302 (e.g., a router 154), a REED 400 (e.g., an end device 152, such as the potential parent device 304 of FIG. 3), and a REED 402 (e.g., another end device 152 in the mesh network 150).

FIG. 4 also indicates how the device 300 (e.g., in the use case of FIG. 4, in which the device 300 is a new device to the mesh network 150) can also help to reduce the time for attachment of the device 300 to the mesh network 150. For example, the device 300 may (e.g., instead of waiting for multiple parent responses from multiple routers and/or REEDs in the mesh network 150, and then comparing the parent responses to each other to select a parent device) select, as a parent device, the first responding device that meets one or more parent criteria of the device 300. For example, the parent criteria for the device 300 may include any or all of the mesh-impacting criteria and/or any or all of the child-impacting criteria described above in connection with the reduced jitter time of the potential parent device 302.

In the example of FIG. 4, the device 300 selects the potential parent device 302 as its parent based on the parent response from the potential parent device 302 (e.g., and sends a child ID request to the potential parent device 302), even before additional parent responses (e.g., from the REED 400 and/or the REED 402) are received (e.g., the device 300 does not wait for and/or process parent responses that arrive after a satisfactory parent response has been received). By dynamically reducing the jitter time for potential parent devices that satisfy certain criteria, and by selecting the first device that satisfies the parent criteria as the parent device, the time for the device 300 to attach to the mesh network 150 is reduced.

In one or more implementations, the parent responses from the potential parent device 302, the REED 400, and the REED 402 may each include attribute information for that device. As examples, the attribute information for the potential parent device 302 (e.g., which the device 300 may compare to one or more respective thresholds, as discussed herein, when the parent response indicating the attributes is received) may include a two-way link quality for the device 300, a parent priority value for the device 300, a number of neighbors for the device 300 that have a good two-way link quality, a version number for the device 300, a child buffer size for the device 300, and/or a child datagram count for the device 300.

The example of FIG. 4 illustrates a full attach procedure for a use case in which the device 300 is a new (e.g., unattached) device to the mesh network 150 (e.g., has never attached, or has been detached for greater than a predetermined period of time). However, as discussed herein, in other use cases, the device 300 that is detached from the mesh network 150 may have previously been attached to the mesh network (e.g., using the full attach procedure described in connection with FIG. 4), and then later become detached (e.g., due to a temporary loss of power at the device 300, an outage in all or part of the mesh network 150, a software update at the device 300 or its parent device, a restart of the device 300 or its parent device, or a temporary loss of communications capabilities at the device 300). In these use cases, the device 300 may store a child identifier (ID), such as the child ID 281 of FIG. 2, in persistent memory (e.g., memory 214, such as memory that can continue to store the child ID in the event of a loss of power at the device 300 and/or a restart of the device 300) at the device 300.

As discussed herein, the prior parent device (e.g., the potential parent device 302 after having been selected as the parent device and providing the child ID to the device 300) of the device 300 may also store the child ID that was previously provided to the device 300 during the prior attach procedure. However, the prior parent device may only store the child ID of the device 300 for a predetermined period of time, and may then delete the child ID of the device 300 from its memory. Thus, if the device 300 attempts to re-attach to the prior parent device using the child ID stored in its memory after the prior parent device has deleted that child ID, time may be wasted unsuccessfully attempting to re-attached with the child ID that could otherwise be used to perform a new full attach procedure to re-attach to the mesh network 150.

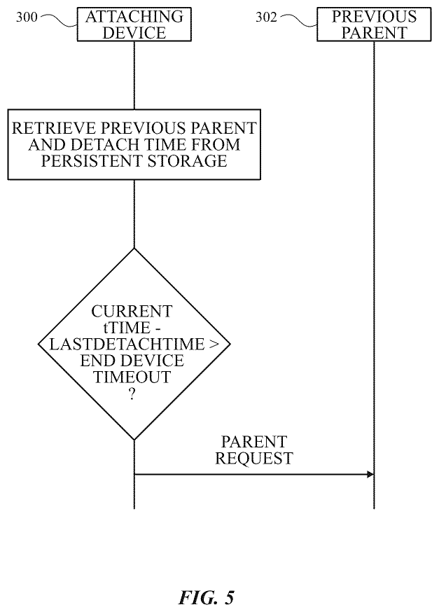

In one or more implementations, in addition to storing the child ID, in the event of a detachment from the mesh network 150, the device 300 may also store a detach time (e.g., the time at which the device 300 detached, such as a time of a last received communication or a first missing communication from its parent device) in its persistent memory. As shown in the sequence diagram of FIG. 5, when the device 300 is ready to attempt to re-attach to the mesh network 150 (e.g., when power is restored at the device 300 or its parent device, or a restart of the device 300 or its parent device is complete), the device 300 may retrieve the child ID and the detach time (e.g., and information identifying the previous parent) from its persistent memory. The device 300 may determine, at a later time following the detach time, whether an amount of time between the later time (e.g., the current time) and the detach time is greater than or less than a threshold amount of time (e.g., an end device timeout in FIG. 5). For example, the threshold amount of time may be (e.g., approximately) equal to the predetermined amount of time that the child ID is stored by the parent device after a detachment.

In a use case in which the amount of time is less than the threshold amount of time, the device 300 may provide an update request to its prior parent device. In one or more implementations, the update request may include the child ID for the device 300. The prior parent device may then determine whether the child ID is valid and, if so, provide a response including the requested update and/or link to allow the device 300 to re-attach to the prior parent device using the child ID.

As shown in FIG. 5, in a use case in which the amount of time is greater than the threshold amount of time, the device 300 may provide (e.g., multicast) a join request (e.g., a parent request) to one or more other devices of the mesh network (e.g., using the full attach procedure described herein in connection with FIG. 4) without first providing any update requests to its prior parent device. By proceeding directly to the full attach procedure if the amount of time is greater than the threshold amount of time, the device 300 may more quickly re-attach to the mesh network 150.

In the example of FIG. 5, the device 300 is an end device that determines whether to re-attach to a router that was its prior parent device, or to perform a full attach procedure to obtain a new parent device. However, it is also appreciated that the operations of FIG. 5 may be performed by a router 154 attempting to re-attach to the leader 154L. In this example of a router 154 attempting to re-attach to the leader 154L, the child ID may be replaced by a routing locator (RLOC) provided by the leader 154L for the router 154, and the router 154 may provide an update request and a link request to the leader 154L if the amount of time is greater than the threshold amount of time.

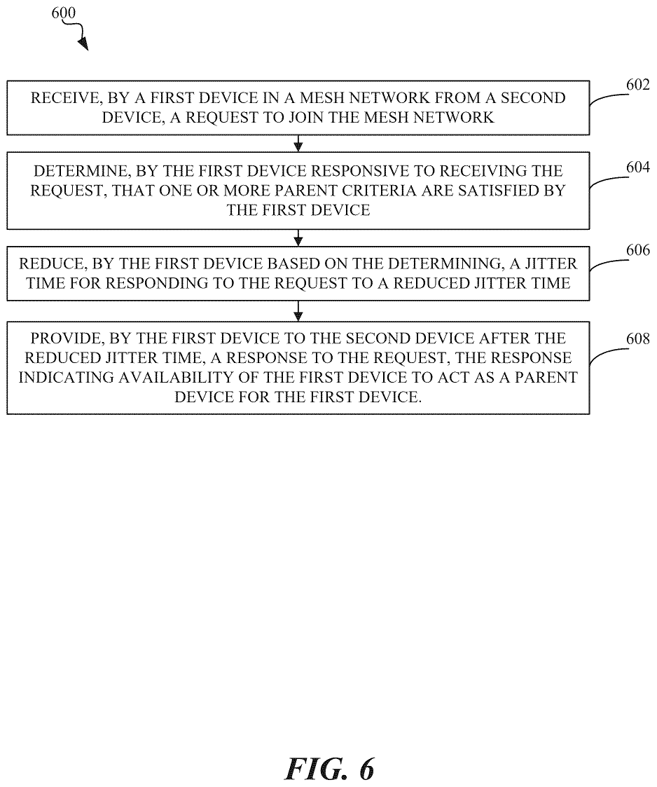

FIG. 6 is a flow chart of an example process 600 that may be performed for attaching a device to a mesh network in accordance with one or more implementations. For explanatory purposes, the process 600 is primarily described herein with reference to a router 154 of FIGS. 1 and 3. However, the process 600 is not limited to the router 154 of FIGS. 1 and 3, and one or more blocks (or operations) of the process 600 may be performed by one or more other components of other suitable devices and/or servers. Further for explanatory purposes, some of the blocks of the process 600 are described herein as occurring in serial, or linearly. However, multiple blocks of the process 600 may occur in parallel. In addition, the blocks of the process 600 need not be performed in the order shown and/or one or more blocks of the process 600 need not be performed and/or can be replaced by other operations.

As illustrated in FIG. 6, at block 602, a first device (e.g., a router 154 such as potential parent device 302, a REED 400, or a REED 402) in a mesh network (e.g., mesh network 150) may receive, from a second device (e.g., an unattached device, such as device 300), a request to join the mesh network. For example, the request to join the mesh network may be in the form of a parent request, such as a MLE parent request. In one or more implementations, receiving the request includes receiving the request at the first device while the first device is operating as a parent device to at least a third device (e.g., an end device 152) in the mesh network. In one or more implementations, receiving the request includes receiving the request at the first device while the first device is operating as an end device and is eligible to upgrade to operate as a router in the mesh network.

At block 604, the first device may determine, responsive to receiving the request, that one or more parent criteria are satisfied by the first device. As examples, the one or more parent criteria may include one or more of: the first device is operating as a router (e.g., an active router, such as a router 154) in the mesh network, a link quality (e.g., a two-way link quality) of a connection between the first device and the second device is at least a threshold quality (e.g., very good (3)), the first device has a parent priority value above a threshold priority value (e.g., N), or the first device has a number of neighbor devices (e.g., one-hop neighbors and/or neighbors with a two-way link quality of at least another quality threshold) in the mesh network greater than a threshold number (e.g., k) of neighbors. In one or more implementations, one or more of the parent criteria may be specified in the request. In one or more other implementations, the one or more parent criteria may be stored (e.g., preprogrammed) at the first device prior to receiving the request.

In one or more implementations, the request includes a child version number for the second device, and the one or more parent criteria include a version number for the first device that is greater than the child version number. In one or more implementations, the request includes a desired buffer size for the second device, and the one or more parent criteria include a buffer size (e.g., a RX-Off child buffer size) greater than or equal to the desired buffer size. In one or more implementations, the request includes a desired datagram count for the second device, and the one or more parent criteria include a datagram count (e.g., a RX-Off child datagram count) for the first device that is greater than or equal to the desired datagram count.

At block 606, the first device may reduce, based on the determining, a jitter time for responding to the request to a reduced jitter time. In one or more implementations, reducing the jitter time may include reducing the jitter time by at least a factor of three (e.g., or more than a factor of three, such as a factor of five or more, such as from a default value of 0.5 seconds to one hundred milliseconds or less than one hundred milliseconds).

At block 608, the first device may provide (e.g., send or transmit) to the second device after the reduced jitter time, a response (e.g., a parent response, such as an MLE parent response) to the request, the response indicating availability of the first device to act as a parent device for the first device. Following the response, the first device may receive a child request from the second device, and provide a child ID to the second device, or may not receive any further requests from the second device (e.g., if the second device selects another device in the mesh network as its parent device).

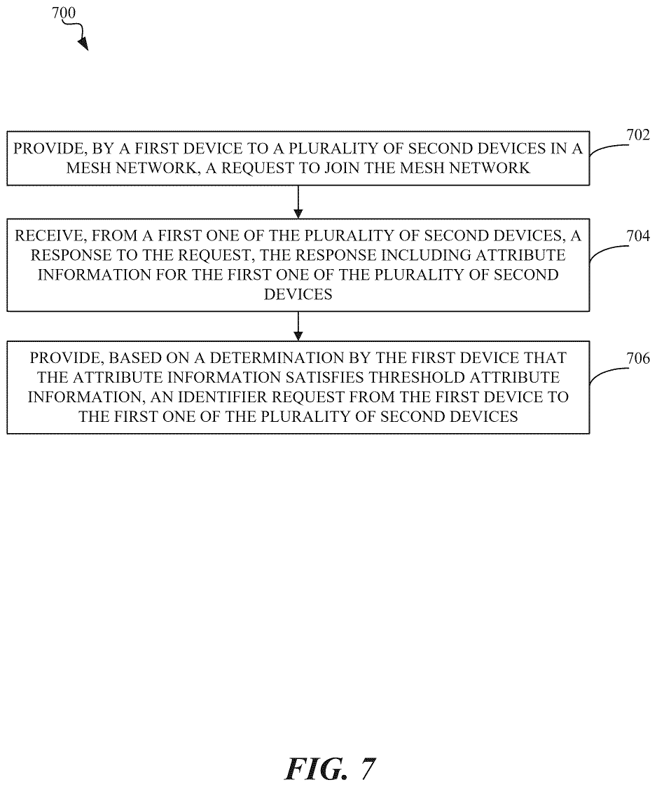

FIG. 7 is a flow chart of an example process 700 that may be performed for attaching a device to a mesh network in accordance with one or more implementations. For explanatory purposes, the process 700 is primarily described herein with reference to an end device 152 of FIGS. 1 and 3. However, the process 700 is not limited to the end device 152 of FIGS. 1 and 3, and one or more blocks (or operations) of the process 700 may be performed by one or more other components of other suitable devices and/or servers. Further for explanatory purposes, some of the blocks of the process 700 are described herein as occurring in serial, or linearly. However, multiple blocks of the process 700 may occur in parallel. In addition, the blocks of the process 700 need not be performed in the order shown and/or one or more blocks of the process 700 need not be performed and/or can be replaced by other operations.

As illustrated in FIG. 7, at block 702, a first device (e.g., device 300) may provide (e.g., multicast) to a plurality of second devices (e.g., routers 154 and/or REEDs which may be acting as end devices 152, such as REED 400 and/or REED 402 of FIG. 4) in a mesh network (e.g., mesh network 150), a request to join the mesh network. For example, the request to join the mesh network may be in the form of a parent request, such as a MLE parent request.

At block 704, the first device may receive, from a first one (e.g., potential parent device 302) of the plurality of second devices, a response (e.g., a parent response, such as an MLE parent response) to the request. The response may include attribute information for the first one of the plurality of second devices. As examples, the attribute information may include a two-way link quality for the first one of the plurality of second devices, a parent priority value for the first one of the plurality of second devices, and/or a number of neighbors (e.g., neighbors with a two-way link quality of at least an additional quality threshold) for the first one of the plurality of second devices. As additional examples, the attribute information may include a version number for the first one of the plurality of second devices, a child buffer size (e.g., a RX-Off child buffer size) for the first one of the plurality of second devices, and/or a child datagram count (e.g., a RX-Off child datagram count) for the first one of the plurality of second devices.

At block 706, the first device may provide (e.g., send or transmit, such as via a unicast transmission), based on a determination by the first device that the attribute information satisfies threshold attribute information, an identifier request (e.g., a child ID request, such as an MLE child ID request) to the first one of the plurality of second devices. For example, the first device may determine, prior to providing the identifier request, whether the attribute information satisfies threshold attribute information. In one or more implementations, the identifier request includes a child identifier request (e.g., an MLD child ID request) for identifying the first device as a child (e.g., a child device) of the first one of the plurality of second devices.

In one or more implementations, the first device may also receive, from a second one (e.g., REED 400 of FIG. 4) of the plurality of second devices, an additional response (e.g., an additional parent response, such as an additional MLE parent response) to the request, the additional response including additional attribute information for the second one of the plurality of second devices. For example, receiving the additional response may include receiving the additional response after receiving the response and prior to providing the identifier request. For example, receiving the additional response may include receiving the additional response while (or after) determining, at the first device, whether the attribute information satisfies the threshold attribute information. The first device may provide, at block 706, the identifier request to the first one of the plurality of second devices without processing, at the first device, the additional response (e.g., without comparing the additional attribute information for the second one of the plurality of second devices to the attribute information for the first one of the plurality of second devices, and/or without comparing the additional attribute information for the second one of the plurality of second devices to any thresholds). In one or more implementations, the first device may forego, based on the determination that the attribute information satisfies the threshold, receipt of responses from other second devices of the plurality of second devices.

Responsive to the identifier request, the first device may receive, from the first one of the plurality of second devices, an identifier (e.g., a child ID), and may use the child ID to attach to the mesh network and maintain the attachment to the mesh network.

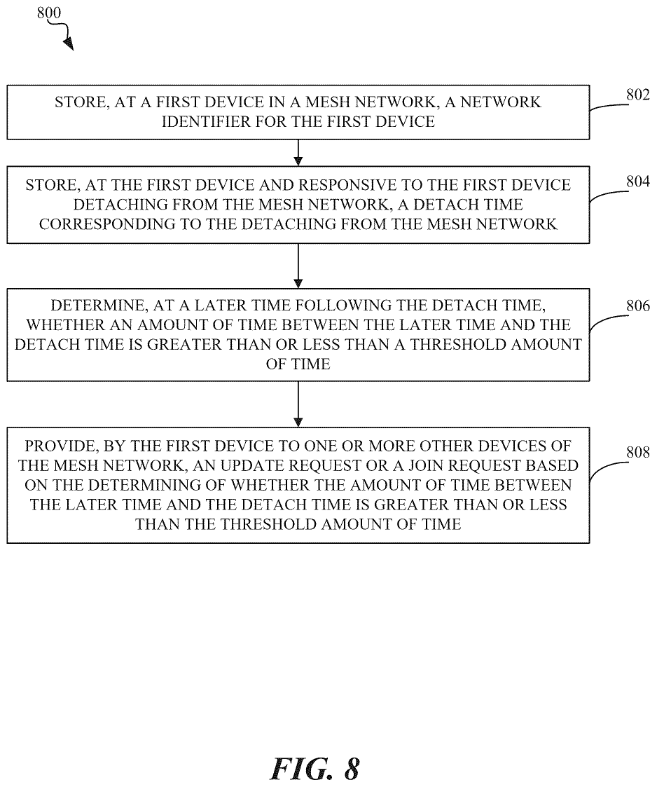

FIG. 8 is a flow chart of an example process 800 that may be performed for re-attaching a device to a mesh network in accordance with one or more implementations. For explanatory purposes, the process 800 is primarily described herein with reference to an end device 152 of FIGS. 1 and 3. However, the process 800 is not limited to the end device 152 of FIGS. 1 and 3, and one or more blocks (or operations) of the process 800 may be performed by one or more other components of other suitable devices and/or servers. Further for explanatory purposes, some of the blocks of the process 800 are described herein as occurring in serial, or linearly. However, multiple blocks of the process 800 may occur in parallel. In addition, the blocks of the process 800 need not be performed in the order shown and/or one or more blocks of the process 800 need not be performed and/or can be replaced by other operations.

As illustrated in FIG. 8, at block 802, a first device (e.g., an end device 152) in (e.g., attached to) a mesh network (e.g., mesh network 150) may store a network identifier (e.g., a child ID, such as the child ID 281 of FIG. 2) for the first device. Storing the network identifier may include storing the network identifier in a persistent memory (e.g., memory 214) at the first device.

At block 804, the first device may store, responsive to the first device detaching from the mesh network, a detach time corresponding to the detaching from the mesh network. For example, the detaching may be due to an outage in the mesh network, a power outage at the first device or a parent device, or another loss of communication between the first device and its parent device. Storing the detach time may include storing the detach time along with the network identifier in a persistent memory (e.g., memory 214) at the first device.

At block 806, the first device may determine, at a later time (e.g., a current time) following the detach time, whether an amount of time between the later time and the detach time is greater than or less than a threshold amount of time.

At block 808, the first device may provide (e.g., send or transmit) to one or more other devices of the mesh network responsive to the determining, an update request or a join request according to the determining of whether the amount of time between the later time and the detach time is greater than or less than the threshold amount of time.

In one or more use cases, the first device is an end device (e.g., an end device 152), the determining at block 806 includes determining that the amount of time is less than the threshold amount of time, and the providing at block 808 includes providing the update request to a second device (e.g., a router 154) that was a prior parent device for the first device prior to the detaching of the first device from the mesh network.

In one or more other use cases, the first device is a device (e.g., a router or a REED) acting as a router (e.g., a router 154) in the mesh network, the determining at block 806 includes determining that the amount of time is less than the threshold amount of time, and the providing at block 808 includes providing the update request and a link request to a device (e.g., a router) that was acting as a leader (e.g., leader 154L) in the mesh network prior to the detaching of the first device from the mesh network. In these use cases, the network identifier may be a routing locator (RLOC) for the first device.

In one or more other use cases, the determining at block 806 includes determining that the amount of time is greater than the threshold amount of time, and the providing at block 808 includes providing the join request (e.g., the parent request) to the one or more other devices of the mesh network (e.g., by multicasting the parent request to multiple routers and/or REEDs) without first providing any update requests to a prior parent device of the first device.

FIG. 9 illustrates an electronic system 900 with which one or more implementations of the subject technology may be implemented. The electronic system 900 can be, and/or can be a part of, any one of the electronic devices 110 or 112, the end devices 152, the router 154, and/or the server 120 shown in FIG. 1. The electronic system 900 may include various types of computer readable media and interfaces for various other types of computer readable media. The electronic system 900 includes a bus 908, one or more processing unit(s) 912, a system memory 904 (and/or buffer), a ROM 910, a permanent storage device 902, an input device interface 914, an output device interface 906, and one or more network interfaces 916, or subsets and variations thereof.

The bus 908 collectively represents all system, peripheral, and chipset buses that communicatively connect the numerous internal devices of the electronic system 900. In one or more implementations, the bus 908 communicatively connects the one or more processing unit(s) 912 with the ROM 910, the system memory 904, and the permanent storage device 902. From these various memory units, the one or more processing unit(s) 912 retrieves instructions to execute and data to process in order to execute the processes of the subject disclosure. The one or more processing unit(s) 912 can be a single processor or a multi-core processor in different implementations.

The ROM 910 stores static data and instructions that are needed by the one or more processing unit(s) 912 and other modules of the electronic system 900. The permanent storage device 902, on the other hand, may be a read-and-write memory device. The permanent storage device 902 may be a non-volatile memory unit that stores instructions and data even when the electronic system 900 is off. In one or more implementations, a mass-storage device (such as a magnetic or optical disk and its corresponding disk drive) may be used as the permanent storage device 902.

In one or more implementations, a removable storage device (such as a flash drive, and its corresponding solid-state drive) may be used as the permanent storage device 902. Like the permanent storage device 902, the system memory 904 may be a read-and-write memory device. However, unlike the permanent storage device 902, the system memory 904 may be a volatile read-and-write memory, such as random-access memory. The system memory 904 may store any of the instructions and data that one or more processing unit(s) 912 may need at runtime. In one or more implementations, the processes of the subject disclosure are stored in the system memory 904, the permanent storage device 902, and/or the ROM 910. From these various memory units, the one or more processing unit(s) 912 retrieves instructions to execute and data to process in order to execute the processes of one or more implementations.

The bus 908 also connects to the input device interface 914 and output device interface 906. The input device interface 914 enables a user to communicate information and select commands to the electronic system 900. Input devices that may be used with the input device interface 914 may include, for example, alphanumeric keyboards and pointing devices (also called “cursor control devices”). The output device interface 906 may enable, for example, the display of images generated by electronic system 900. Output devices that may be used with the output device interface 906 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 9, the bus 908 also couples the electronic system 900 to one or more networks and/or to one or more network nodes, such as the electronic device 110 shown in FIG. 1, through the one or more network interface(s) 916. In this manner, the electronic system 900 can be a part of a network of computers (such as a LAN, a wide area network (“WAN”), or an Intranet, or a network of networks, such as the Internet. Any or all components of the electronic system 900 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “router”, “end device”, “transceiver”, “processor”, and “memory” all refer to electronic or other technological devices. These terms exclude people or groups of people. For the purposes of the specification, the terms “display”or “displaying”means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise”is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
receiving, by a first device in a mesh network from a second device, a request to join the mesh network;
determining, by the first device responsive to receiving the request, that one or more parent criteria are satisfied by the first device;
reducing, by the first device based on the determining, a jitter time for responding to the request to a reduced jitter time; and
providing, by the first device to the second device after the reduced jitter time, a response to the request, the response indicating availability of the first device to act as a parent device for the first device.

2. The method of claim 1, wherein receiving the request comprises receiving the request at the first device while the first device is operating as a parent device to at least a third device in the mesh network.

3. The method of claim 1, wherein the one or more parent criteria include one or more of:
the first device is operating as a router in the mesh network,
a link quality of a connection between the first device and the second device is at least a threshold quality,
the first device has a parent priority value above a threshold priority value, or
the first device has a number of neighbor devices in the mesh network greater than a threshold number of neighbors.

4. The method of claim 1, wherein one or more of the parent criteria are specified in the request, and wherein reducing the jitter time comprises reducing the jitter time by at least a factor of three.

5. The method of claim 1, wherein the request includes a child version number for the second device, and wherein the one or more parent criteria comprise a version number for the first device that is greater than the child version number.

6. The method of claim 1, wherein the request includes a desired buffer size for the second device, and wherein the one or more parent criteria comprise a buffer size greater than or equal to the desired buffer size.

7. The method of claim 1, wherein the request includes a desired datagram count for the second device, and wherein the one or more parent criteria comprise a datagram count for the first device that is greater than or equal to the desired datagram count.

8. A method, comprising:
providing, by a first device to a plurality of second devices in a mesh network, a request to join the mesh network;
receiving, from a first one of the plurality of second devices, a response to the request, the response including attribute information for the first one of the plurality of second devices; and
providing, based on a determination by the first device that the attribute information satisfies threshold attribute information, an identifier request from the first device to the first one of the plurality of second devices.

9. The method of claim 8, wherein the identifier request comprises a child identifier request for identifying the first device as a child of the first one of the plurality of second devices.

10. The method of claim 8, further comprising:
receiving, from a second one of the plurality of second devices, an additional response to the request, the additional response including additional attribute information for the second one of the plurality of second devices; and
providing the identifier request from the first device to the first one of the plurality of second devices without processing, at the first device, the additional response.

11. The method of claim 10, wherein receiving the additional response comprises receiving the additional response after receiving the response and prior to providing the identifier request.

12. The method of claim 11, wherein receiving the additional response comprises receiving the additional response while determining, at the first device, whether the attribute information satisfies the threshold attribute information.

13. The method of claim 8, further comprising foregoing, based on the determination that the attribute information satisfies the threshold attribute information, receipt, by the first device, of responses from other second devices of the plurality of second devices.

14. The method of claim 8, wherein the attribute information comprises at least one of:
a two-way link quality for the first one of the plurality of second devices,
a parent priority value for the first one of the plurality of second devices, or
a number of neighbors for the first one of the plurality of second devices.

15. The method of claim 8, wherein the attribute information comprises at least one of:
a version number for the first one of the plurality of second devices,
a child buffer size for the first one of the plurality of second devices,
a child datagram count for the first one of the plurality of second devices.

16. A method, comprising:
storing, at a first device in a mesh network, a network identifier for the first device;
storing, at the first device and responsive to the first device detaching from the mesh network, a detach time corresponding to the detaching from the mesh network;
determining, at a later time following the detach time, whether an amount of time between the later time and the detach time is greater than or less than a threshold amount of time; and
providing, by the first device to one or more other devices of the mesh network responsive to the determining, an update request or a join request according to the determining of whether the amount of time between the later time and the detach time is greater than or less than the threshold amount of time.

17. The method of claim 16, wherein the detaching is due to an outage in the mesh network.

18. The method of claim 16, wherein storing the detach time comprises storing the detach time along with the network identifier in a persistent memory at the first device.

19. The method of claim 16, wherein the first device comprises an end device, wherein the determining comprises determining that the amount of time is less than the threshold amount of time, and wherein the providing comprises providing the update request to a second device that was a prior parent device for the first device prior to the detaching of the first device from the mesh network.

20. The method of claim 16, wherein the first device comprises a device acting as a router in the mesh network, wherein the determining comprises determining that the amount of time is less than the threshold amount of time, and wherein the providing comprises providing the update request and a link request to a device that was acting as a leader in the mesh network prior to the detaching of the first device from the mesh network.

21. The method of claim 16, wherein the determining comprises determining that the amount of time is greater than the threshold amount of time, and wherein the providing comprises providing the join request to the one or more other devices of the mesh network without first providing any update requests to a prior parent device of the first device.
